(19) United States
(12) Patent Application Publication
(10) Pub. No.: US 2006/0172901 A1
(43) Pub. Date: Aug. 3, 2006

(54) Release agent composition for plastic mold and component using the same

(75) Inventors: Sumire Kubota, Kawasaki-Shi (JP); Hirohide Matsuhisa, Yokohama-Shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/319,202

(22) Filed: Dec. 28, 2005

(30) Foreign Application Priority Data
Jan. 7, 2005 (JP) 2005-002700

(51) Int. Cl. B28B 7/36; C10M 105/54

(52) U.S. Cl. 508/582; 508/438; 508/590; 106/38.22

(57) ABSTRACT

There is provided a novel nonflammable release agent composition for a plastic mold containing: (a) a hydrofluoroether; (b) fluorine oil; and (c) a fluorine-based surfactant, in which the content of the ingredient (a) is 50 wt % or more. The composition is lowly toxic, noncombustible, and more chemically stable than a conventional one, and brings together high persistence of releasability and sufficient durability.

### BACKGROUND OF THE INVENTION

1. Field of the Invention

The present invention relates to a composition capable of reducing a load to the global environment. The present invention relates to a release agent composition which has a low global warming potential and which is lowly toxic, noncombustible, and chemically stable.

2. Related Background Art

Release agents for plastic molds are classified into an inexpensive silicone-based release agent and a fluorine-based release agent which is expensive but has good fabrication quality. Of those, the latter, that is, the fluorine-based release agent has currently gone into the mainstream of a release agent for a plastic mold because of, for example, the following reasons. One reason is that the amount of the fluorine-based release agent to be used can be small. Another reason is that the fluorine-based release agent hardly causes the contamination of a die. Still another reason is that the fluorine-based release agent hardly transfers to a molded article.

In many cases, active ingredients for such fluorine-based release agent are fluorine oil, a fluorine resin, a fluorine-based surfactant, and the like. As required, the fluorine-based release agent is added with silicone oil, a binder resin, or the like to be diluted into perfluorocarbon (hereinafter abbreviated as PFC). Such PFC has appropriate solubility with respect to an organic fluoride compound as a principal ingredient, and has an appropriate boiling point so that it can be volatilized. Furthermore, the PFC has low toxicity with respect to a human body and is noncombustible, so it has been vigorously used as a solvent (see Japanese Patent Application Laid-open No. 2000-94455).

Global warming has become serious in recent environmental problems. Enforcement of Kyoto Protocol intended for suppressing an amount of emission of CO₂ has been embodied as one measure to prevent global warming. PFC used for a fluorine-based release agent described above has a high global warming potential, so it has become a substance whose amount must be reduced. In addition, the shape of a plastic molded article has become complicated and enlarged, so an additional improvement of performance of a release agent has been required. In particular, an improvement of a release agent has been desired.

An object of the present invention is to provide, as a solvent alternative to PFC, a release agent composition which has a low global warming potential and which is lowly toxic, noncombustible, compatible with fluorine oil and a fluorine-based surfactant, and chemically stable.

Another object of the present invention is to provide a component obtained by molding the novel release agent composition.

### SUMMARY OF THE INVENTION

The inventors of the present invention have made extensive studies with a view to alleviating a defect, that is, low persistence of a release force described above. As a result, they have found that a fluorine-based surfactant out of the active ingredients for a release agent composition for a plastic mold greatly serves as a key material, to thereby complete the present invention.

That is, they have found that not only release by the cohesion failure of fluorine oil but also release by the interfacial peeling of a fluorine-based surfactant is required for obtaining a nonflammable release agent composition for a plastic mold having high persistence of a release force.

According to the present invention, there are provided:

(1) a nonflammable release agent composition for a plastic mold containing: (a) a hydrofluoroether; (b) fluorine oil; and (c) a fluorine-based surfactant, in which the content of the ingredient (a) is 50 wt % or more to impart nonflammability;

(2) the nonflammable release agent composition for a plastic mold according to the above item (1), in which the total content of the ingredient (b) and the ingredient (c) is 0.10 wt % or more and 10.0 wt % or less with respect to the entire composition;

(3) the nonflammable release agent composition for a plastic mold according to the above item (1) or (2), in which the ingredient (a) has a boiling point of 20° C. or higher and lower than 110° C., and has no flash point;

(4) the nonflammable release agent composition for a plastic mold according to any one of the above items (1) to (3), in which the ingredient (a) is represented by a molecular formula selected from the group consisting of C₄F₉OCH₃₁ C₄F₉OC₂H₅, and CHF₂CF₂OCH₂CF₃;

(5) the nonflammable release agent composition for a plastic mold according to any one of the above items (1) to (4), in which the fluorine oil as the ingredient (b) has a vapor pressure of less than 667 Pa at 150° C.;

(6) the nonflammable release agent composition for a plastic mold according to any one of the above items (1) to (5), in which the fluorine oil as the ingredient (b) has a surface tension of less than 3.2×10⁻² N/m at 25° C.;

(7) a nonflammable release agent composition for a plastic mold according to any one of the above items (1) to (6), in which the fluorine oil as the ingredient (b) is any one of the compounds represented by the following molecular formulae:
X—(CF₂CFCl)ₙ—X (2≦n≦10, n represents an integer; X=Cl or F);
Y—(C₃F₆O)ₘ—Y (10≦m≦50, m represents an integer; Y=F or a perfluoroalkyl group);
CF₃O—[(C₃F₆O)ₗ—(CF₂O) K]—CF₃ (10≦1+K≦50, l and K each represent an integer); or
CF₃O—[(C₂F₄O)ₗ—(CF₂O) K]—CF₃ (10≦1+K≦50, l and K each represent an integer); or
a mixture of the compounds;
(8) the nonflammable release agent composition for a plastic mold according to any one of the above items (1) to (7), in which a surface tension obtained by adding the fluorine-based surfactant as the ingredient (c) to an aqueous solution system has a value of 2.00×10⁻² N/m or less;
(9) the nonflammable release agent composition for a plastic mold according to any one of the above items (1) to (8), in which the fluorine-based surfactant as the ingredient (c) is a fluorine-containing phosphoric ester; and
(10) the component obtained by molding the nonflammable release agent composition for a plastic mold according to any one of the above items (1) to (9).

According to the present invention, a nonflammable and highly safe release agent composition for a plastic mold having sufficient persistence of a release force can be obtained without using an organic fluorine-based solvent such as PFC. In addition, a percent defective upon production of a plastic component can be reduced by molding the release agent.

The release agent composition of the present invention is lowly toxic, noncombustible, and more chemically stable than a conventional one as a result of the use of a solvent having a low global warming potential and the addition of a fluorine-based surfactant. Therefore, a novel nonflammable release agent composition for a plastic mold bringing together high persistence of releasability and sufficient durability can be provided.

In addition, a component obtained by molding a novel release agent having durability can contribute to a reduction in percent defective because the sticking of the component and the remaining release agent immediately after the application of the release agent reduce.

Other features and advantages of the present invention will be apparent from the following.

### DESCRIPTION OF THE PREFERRED EMBODIMENTS

Hereinafter, the present invention will be described in detail by way of preferred embodiments.

The hydrofluoroether as the ingredient (a) to be used in the present invention can be any one of various hydrofluorothers as long as the hydrofluoroether is a compound having no flash point and having a low global warming potential. The compound preferably has a boiling point of 20° C. or higher and lower than 120° C. in terms of drying property and disappearance of flammability. More specifically, examples of a compound represented by a molecular formula selected from the group consisting of C₄F₉OCH₃, C₄F₉OC₂H₅, and CHF₂CF₂OCH₂CF₃ include, but not limited to, HFE 7100 manufactured by Sumitomo 3M, HFE 7200 manufactured by Sumitomo 3M, and AE 3000 manufactured by ASAHI GLASS CO., LTD.

The content of the hydrofluoroether in the release agent composition for a plastic mold of the present invention is 50 wt % or more. At a content of less than 50 wt %, nonflammability and a low chemical attack, which are characteristics of the hydrofluoroether, do not appear owing to an influence of any other ingredient, with the result that the composition becomes flammable, or a molded article or a die is damaged.

The fluorine oil as the ingredient (b) to be used in the present invention preferably firstly has a low surface tension in order to secure releasability. The surface tension of the fluorine oil is particularly preferably less than 3.2×10⁻² N/m at 25° C. Oil having a surface tension equal to or higher than 3.2×10⁻² N/m is not preferable for a release agent composition because it provides poor releasability. In addition, oil which has an appropriately low vapor pressure and is hardly volatilized is preferable for stably maintaining releasability even in a die at a high temperature. More specifically, oil having a vapor pressure of less than 667 Pa at 150° C. is suitably used. In terms of structure, for example, a compound obtained by subjecting: a chlorotrifluoroethylene oligomer derivative represented by X—(CF₂CFCl)ₙ—X (2≦n≦10, n represents an integer; X=Cl or F); a hexafluoropropeneoxide (hereinafter abbreviated as HFPO) oligomer derivative represented by Y—(C₃F₆O)ₘ—Y (10≦m≦50, m represents an integer; Y═F or a perfluoroalkyl group); linear perfluoropolyether oil; hexafluoropropene (hereinafter abbreviated as HFP) represented by CF₃O—[(C₃F₆O)ₗ—(CF₂O) K]—CF₃ (10≦l+K 50, l and K each represent an integer); or tetrafluoroethylene (hereinafter abbreviated as TFE) represented by CF₃O—[(C₂F₄O)ₗ—(CF₂O) K]—CF₃ (10≦l+K 50, l and K each represent an integer) to photooxidation polymerization can be used as fluorine oil satisfying those properties.

More specifically, commercially available fluorine oil such as Daifloil #20 manufactured by DAIKIN INDUSTRIES, Ltd., Demnam S-20 manufactured by DAIKIN INDUSTRIES, Ltd., BARRIERTA J60 manufactured by NOK Kluber, FOMBLIN Y06 manufactured by Montecatini (this company's name has been changed to “Salvay Solexis KK”), FOMBLIN M03 manufactured by Montecatini, FOMBLIN Z03 manufactured by Montecatini, or KRYTOX manufactured by Du Pont can be suitably used, but the present invention is not limited to them.

The fluorine-based surfactant as the ingredient (c) serving as a characteristic of the present invention also preferably has a low surface tension in order to secure releasability. The surface tension of water upon addition of the fluorine-based surfactant to an aqueous solution system is preferably 2.00×10⁻² N/m or less. A fluorine-based surfactant having a surface tension higher than 2.00×10⁻² N/m provides poor releasability, so it is hardly used for a release agent composition. Any one of anionic, cationic, nonionic, and amphoteric structures which satisfies the above conditions can be suitably used for the fluorine-based surfactant. A fluorine-containing phosphoric ester-based one is more suitably used. Examples of such ester include, but not limited to, a phosphoric ester represented by a general formula (RfR²⁰)ⱼPO(OR¹)ₖ(OH)ₗ(OM)ₜ, or a salt thereof (in the formula: Rf represents a fluoroalkyl or fluoroalkenyl group having 4 to 20 carbon atoms; M represents an alkali metal atom, an ammonium group, or a substituted ammonium group; R¹ represents an alkyl group having 1 to 5 carbon atoms; R² represents a —CH₂CH(OR³)CH₂— group, provided that R³ represents a hydrogen atom or an alkyl group having 1 to 10 carbon atoms; j represents 1, 2, or 3; 1 represents 2, 1, or 0, provided that the number represented by 1 must be equal to or smaller than (3−j); k represents 2, 1, or 0, provided that the number represented by k must be equal to or smaller than 3−(j+1); and t represents 3−(j+1+k)).

More specifically, each of commercially available fluorine-based surfactants such as: Fluorad FC-135 manufactured by Sumitomo 3M (minimum surface tension: 1.70×10⁻² N/m, ionicity: cationic) and Fluorad FC-129 manufactured by Sumitomo 3M (minimum surface tension: 1.70×10⁻² N/m, ionicity: anionic); EFTOP EF-123A manufactured by Mitsubishi Metal Corporation (minimum surface tension: 1.15×10⁻² [N/m], ionicity: anionic) and EFTOP EF-123B manufactured by Mitsubishi Metal Corporation (minimum surface tension: 1.54×10⁻² N/m, ionicity: anionic); MEGAFAC F-191 manufactured by DAINIPPON INK AND CHEMICALS (minimum surface tension: 1.34×10⁻² N/m, ionicity: anionic) and MEGAFAC F-177 manufactured by DAINIPPON INK AND CHEMICALS (minimum surface tension: 2.00×10⁻² N/m, ionicity: nonionic); SURFLON S-121 manufactured by ASAHI GLASS CO., LTD. (minimum surface tension: 1.62×10⁻² N/m, ionicity: cationic) and SURFLON S-145 manufactured by ASAHI GLASS CO., LTD. (minimum surface tension: 1.70×10⁻² N/m, ionicity: nonionic); and UNIDYNE DS-301 manufactured by DAIKIN INDUSTRIES, Ltd. (minimum surface tension: 1.85×10⁻² N/m, ionicity: amphoteric) and UNIDYNE DS-401 manufactured by DAIKIN INDUSTRIES, Ltd. (minimum surface tension: 1.74×10⁻² N/m, ionicity: nonionic) can be suitably used, but the present invention is not limited to them.

When the total content of (b) the fluorine oil ingredient and (c) the fluorine-based surfactant corresponding to the active solid contents in the release agent composition is excessively large, the releasability of the composition and the persistence of the releasability are good, but the release agent composition adheres to the surface of a molded article to thereby increase the number of initial defective molded articles. In contrast, when the total content is excessively small, the composition does not exhibit sufficient releasability. From the foregoing viewpoints, the total content of the fluorine oil and the fluorine-based surfactant in the release agent composition of the present invention is suitably in the range of 0.10 wt % to 10.0 wt % (both inclusive).

Any one of various additives and co-solvents can be used for the nonflammable release agent composition for a plastic mold of the present invention in addition to the three ingredients (a), (b), and (c) as long as the entire composition does not have flammability.

In general, (a) the hydrofluoroether has low compatibility with any one of various solvents and materials. In view of this, in particular, a compatibilized solvent such as hydrofluorocarbon (hereinafter abbreviated as HFX) or fluorine-containing alcohol is often used for uniformly dissolving (c) the fluorine-based surfactant. A compatibilized solvent may be used even in the case where (c) the fluorine-based surfactant is diluted with a general organic solvent.

The above-described nonflammable release agent composition for a plastic mold of the present invention exerts the same effect in any one of treatment methods such as immersion, brush painting, and spray coating.

The novel release agent having durability of the present invention can reduce the sticking of the component at the time of molding and the remaining release agent immediately after the application of the release agent by being molded. Therefore, a percent defective upon production of such product can be reduced. For example, the release agent is useful in molding a plastic lens, an ink-jet component, or the like. It should be noted that the present invention is not limited to the foregoing molded component.

Hereinafter, the present invention will be described more specifically by way of examples. However, the present invention is not limited to these examples.

### EXAMPLE 1

A release agent composition for a plastic mold having the following composition was prepared.

| | |
|---|---|
| HFE 7100 manufactured by Sumitomo 3M | 92.00 wt % |
| DEMNUM S-20 manufactured by DAIKIN INDUSTRIES, | 0.30 wt % |
| Ltd. | |
| MEGAFAC F-191 manufactured by DAINIPPON INK | 0.20 wt % |
| AND CHEMICALS | |
| Trifluoroethanol | 2.50 wt % |
| 1,3-bistrifluoromethylbenzene | 5.00 wt % |

### EXAMPLE 2

A release agent composition for a plastic mold having the following composition was prepared.

| | |
|---|---|
| HFE 7200 manufactured by Sumitomo 3M | 80.00 wt % |
| FOMBLIN Y06 manufactured by Montecatini | 0.30 wt % |
| Fluorad FC-135 manufactured by Sumitomo 3M | 0.20 wt % |
| IPA | 4.00 wt % |
| 1,3-bistrifluoromethylbenzene | 5.00 wt % |

### EXAMPLE 3

A release agent composition for a plastic mold having the following composition was prepared.

| | |
|---|---|
| AE 3000 manufactured by ASAHI GLASS CO., LTD. | 50.00 wt % |
| Daifloil #20 manufactured by DAIKIN INDUSTRIES, | 0.15 wt % |
| Ltd. | |
| UNIDYNE S-401 manufactured by DAIKIN | 0.20 wt % |
| INDUSTRIES, Ltd. | |
| Trifluoroethanol | 2.50 wt % |
| 1,3-bistrifluoromethylbenzene | 5.00 wt % |

### EXAMPLE 4

A release agent composition for a plastic mold having the following composition was prepared.

| | |
|---|---|
| HFE 7100 manufactured by Sumitomo 3M | 85.00 wt % |
| BARRIERTA J60 manufactured by NOK Kluber | 0.4 wt % |
| EFTOP EF-123A manufactured by Mitsubishi | 0.35 wt % |
| Metal Corporation | |
| IPA | 4.00 wt % |
| 1,3-bistrifluoromethylbenzene | 5.00 wt % |

### COMPARATIVE EXAMPLE 1

A release agent composition for a plastic mold having the following composition was prepared.

| | |
|---|---|
| HFE 7100 manufactured by Sumitomo 3M | 98.00 wt % |
| DEMNUM S-20 manufactured by DAIKIN INDUSTRIES, | 2.00 wt % |
| Ltd. | |

### COMPARATIVE EXAMPLE 2

A release agent composition for a plastic mold having the following composition was prepared.

| | |
|---|---|
| HFE 7100 manufactured by Sumitomo 3M | 75.00 wt % |
| HFE 7200 manufactured by Sumitomo 3M | 24.00 wt % |
| FOMBLIN Y06 manufactured by Montecatini | 1.00 wt % |

### COMPARATIVE EXAMPLE 3

A release agent composition for a plastic mold having the following composition was prepared.

| | |
|---|---|
| AE 3000 manufactured by ASAHI GLASS CO., LTD. | 30.00 wt % |
| Daifloil #20 manufactured by DAIKIN INDUSTRIES, | 0.15 wt % |
| Ltd. | |
| UNIDYNE S-401 manufactured by DAIKIN NDUSTRIES, | 0.20 wt % |
| Ltd. | |
| IPA | 62.00 wt % |
| 1,3-bistrifluoromethylbenzene | 5.00 wt % |

### COMPARATIVE EXAMPLE 4

A release agent composition for a plastic mold having the following composition was prepared.

| | |
|---|---|
| AE 3000 manufactured by ASAHI GLASS CO., LTD. | 85.00 wt % |
| BARRIERTA J60 manufactured by NOK Kluber | 0.02 wt % |
| MEGAFAC F-191 manufactured by DAINIPPON INK | 0.03 wt % |
| AND CHEMICALS | |
| IPA | 5.00 wt % |
| 1,3-bistrifluoromethylbenzene | 5.00 wt % |

### COMPARATIVE EXAMPLE 5

A release agent composition for a plastic mold having the following composition was prepared.

| | |
|---|---|
| HFE 7200 manufactured by Sumitomo 3M | 85.00 wt % |
| Teflon (registered trademark)AF1600 | 15.00 wt % |
| manufactured by Du Pont | |

### COMPARATIVE EXAMPLE 6

A release agent composition for a plastic mold having the following composition was prepared.

| | |
|---|---|
| HFE 7200 manufactured by Sumitomo 3M | 60.00 wt % |
| FOMBLIN Y06 manufactured by Montecatini | 15.00 wt % |
| MEGAFAC F-191 manufactured by DAINIPPON INK | 0.10 wt % |
| AND CHEMICALS | |
| IPA | 5.00 wt % |
| 1,3-bistrifluoromethylbenzene | 20.00 wt % |

Each of the above-described various release agent compositions was evaluated for the following evaluation items.

(Flammability)

Evaluation was performed by means of a Tagliabue closed automatic flash point tester (RFT-101 manufactured by RIGO CO., LTD.) in conformance with JIS k2265. Even the case where no flash point was detected but the enlargement of test flame was observed at an upper portion of an inspection window was denoted by Δ.

(Plastic Resistance)

An immersion test was performed in order to confirm that none of the adverse effects such as dissolution and swelling occurred to plastic to be molded. Each test piece (measuring 15×25×3 mm) was immersed in each of the release agent compositions of the present invention for 1 hour, and a test piece showing a rate of change in weight after the immersion of less than 0.1% was denoted by 0, a test piece showing a rate of change in weight after the immersion of 0.1% or more and less than 1% was denoted by Δ, and a test piece showing a rate of change in weight after the immersion of 1% or more was denoted by x. The following pieces were used as test pieces.

PMMA (acryl): Hitaloid (manufactured by Hitachi Chemical Co., Ltd.)

Polycarbonate (PC): Lexan 123R (manufactured by GE Plastics Japan Ltd.)

Polysulfone (Psu): UDEL Polysulfone

(Releasability)

In order to evaluate releasability, the release agent composition of the present invention was applied to an SPCC steel plate (measuring 15×25×3 mm), and then a solvent was sufficiently dried. The steel plate and the same test piece of PC as that used for the evaluation for plastic resistance were bonded to each other by means of Aron Alpha (manufactured by TOAGOSEI CO., LTD.), and the shear peel force of the resultant was used as physical property alternative to a peel force. A product having a shear peel force of less than 100 gf/cm² was denoted by 0, and a product having a shear peel force of 100 gf/cm² or more was denoted by x.

(Persistence)

After a release agent had been applied to a test die, the number of shots was counted until next sticking occurred. The number of shots was used to evaluate the persistence of a release force. Typified molded resins were Psu and PC. A product showing no sticking even after 5,000 shots or more was denoted by 0, a product showing sticking after 500 shots or more but less than 5,000 shots was denoted by A, and a product showing sticking after less than 500 shots was denoted by x.

(Remaining Release Agent)

A release agent remained on a molded article immediately after the application of the release agent owing to the adhesion of the release agent to the molded article. The case where the remaining release agent disappeared after less than 5 shots when viewed with the eyes was denoted by 0, the case where the remaining release agent disappeared after 5 shots or more but less than 20 shots was denoted by A, and the case where the remaining release agent disappeared after 20 shots or more was denoted by x.

Table 1 summarizes the obtained results.

TABLE 1
Results of evaluation of release agent

| | | Plastic | | | | | | Remaining |
|---|---|---|---|---|---|---|---|---|
| | Flash | resistance | | | | Persistence | | release |
| | point ° C. | PMMA | PC | Psu | Releasability | PC | Psu | agent |
| Example 1 | none | ∘ | ∘ | ∘ | ∘ | ∘ | ∘ | ∘ |
| Example 2 | none | ∘ | ∘ | ∘ | ∘ | ∘ | ∘ | ∘ |
| Example 3 | none | ∘ | ∘ | ∘ | ∘ | ∘ | ∘ | ∘ |
| Example 4 | none | ∘ | ∘ | ∘ | ∘ | ∘ | ∘ | ∘ |
| Comparative | none | ∘ | ∘ | ∘ | ∘ | Δ | x | ∘ |
| Example 1 | | | | | | | | |
| Comparative | none | ∘ | ∘ | ∘ | ∘ | Δ | Δ | ∘ |
| Example 2 | | | | | | | | |
| Comparative | 35 | ∘ | ∘ | ∘ | ∘ | ∘ | x | ∘ |
| Example 3 | | | | | | | | |
| Comparative | none | ∘ | ∘ | ∘ | Δ | x | x | ∘ |
| Example 4 | | | | | | | | |
| Comparative | none | ∘ | ∘ | ∘ | ∘ | Δ | x | x |
| Example 5 | | | | | | | | |
| Comparative | none | ∘ | ∘ | ∘ | ∘ | Δ | x | x |
| Example 6 | | | | | | | | |

As shown in Table 1, the release agent composition of the present invention is lowly toxic, noncombustible, and more chemically stable than a conventional one as a result of the use of a solvent having a low global warming potential and the addition of a fluorine-based surfactant. Therefore, a novel nonflammable release agent composition for a plastic mold bringing together high persistence of releasability and sufficient durability can be provided.

In addition, a component obtained by molding a novel release agent having durability can contribute to a reduction in percent defective because the sticking of the component and the remaining release agent immediately after the application of the release agent reduce.

This application claims priority from Japanese Patent Application No. 2005-002700 filed Jan. 7, 2005, which is hereby incorporated by reference herein.

What is claimed is:

1. A nonflammable release agent composition for a plastic mold comprising:
(a) a hydrofluoroether;
(b) fluorine oil; and
(c) a fluorine-based surfactant,
wherein a content of the ingredient (a) is 50 wt % or more to impart nonflammability.

2. The nonflammable release agent composition for a plastic mold according to claim 1, wherein a total content of the ingredient (b) and the ingredient (c) is 0.10 wt % or more and 10.0 wt % or less with respect to an entire composition.

3. The nonflammable release agent composition for a plastic mold according to claim 1, wherein the ingredient (a) has a boiling point of 20° C. or higher and lower than 110° C., and has no flash point.

4. The nonflammable release agent composition for a plastic mold according to claim 1, wherein the ingredient (a) is represented by a molecular formula selected from the group consisting of C₄F₉OCH₃, C₄F₉OC₂H₅, and CHF₂CF₂OCH₂CF₃.

5. The nonflammable release agent composition for a plastic mold according to claim 1, wherein the fluorine oil as the ingredient (b) has a vapor pressure of less than 667 Pa at 150° C.

6. The nonflammable release agent composition for a plastic mold according to claim 1, wherein the fluorine oil as the ingredient (b) has a surface tension of less than 3.2×10⁻² N/m at 25° C.

7. The nonflammable release agent composition for a plastic mold according to claim 1, wherein the fluorine oil as the ingredient (b) comprises one of: any one of the compounds represented by the following molecular formulae:
X—(CF₂CFCl)ₙ—X (2≦n≦10, n represents an integer; X=Cl or F);
Y—(C₃F₆O)ₘ—Y (10≦m≦50, m represents an integer; Y=F or a perfluoroalkyl group);
CF₃O—[(C₃F₆O)—(CF₂O)_{K}]—CF₃ (10≦1+K≦50, l and K each represent an integer); or
CF₃O—[(C₂F₄O)ₗ—(CF₂O) K]—CF₃ (10≦l+K≦50, l and K each represent an integer); and
a mixture of the compounds.

8. The nonflammable release agent composition for a plastic mold according to claim 1, wherein a surface tension obtained by adding the fluorine-based surfactant as the ingredient (c) to an aqueous solution system has a value of 2.00×10⁻² N/m or less.

9. The nonflammable release agent composition for a plastic mold according to claim 1, wherein the fluorine-based surfactant as the ingredient (c) has a fluorine-containing phosphoric ester skeleton.

10. A component obtained by molding the nonflammable release agent composition for a plastic mold according to claim 1.
